(19) United States
(12) Patent Application Publication
(10) Pub. No.: US 2009/0204672 A1
(43) Pub. Date: Aug. 13, 2009

(54) CLIENT-SERVER SYSTEM FOR PERMISSIONS-BASED LOCATING SERVICES AND LOCATION-BASED ADVERTISING

(75) Inventors: ZEENAT JETHA, North Vancouver (CA); Vincent Ting, Vancouver (CA)

Correspondence Address: McCarthy Tetrault LLP, Box 48, Suite #4700 Toronto Dominion Bank Tower, TORONTO, ON, M5K 1E6, CA

(73) Assignee: Idelix Software Inc., Vancouver (CA)

(21) Appl. No.: 12/369,068

(22) Filed: Feb. 11, 2009

Related U.S. Application Data
(60) Provisional application No. 61/028,039, filed on Feb. 12, 2008.

(51) Int. Cl. G06F 15/16

(52) U.S. Cl. 709/204

(57) ABSTRACT

A method in a server coupled to a device through a network for delivering message content to the device, the method comprising: maintaining at the server a message content store, the message content store including message content sorted by geographic position, class, and subclass; receiving at the server from the device a request message for message content, the request message including a geographic position of the device, an extent of a geographic region surrounding the geographic position of the device, a class, and a subclass; determining at the server the message content using the geographic position, the extent, the class, and the subclass; and, sending a response message including the message content from the server to the device, wherein the message content is displayed on a display screen of the device.

This application claims priority from U.S. Provisional Patent Application No. 61/028,039, filed Feb. 12, 2008, and incorporated herein by reference.

### FIELD OF THE INVENTION

This invention relates to the field of wireless and other communications between wireless and other devices, and more specifically, to a method and system for providing permissions-based locating services and location-based advertising for wireless and other devices.

### BACKGROUND OF THE INVENTION

Current wireless mobile communication devices include microprocessors, memory, soundcards, and run one or more software applications in addition to providing for voice communications. Examples of software applications used in these wireless devices include micro-browsers, address books, email clients, instant messaging clients, and wavetable instruments. Additionally, wireless devices have access to a plurality of services via the Internet. A wireless device may, for example, be used to browse web sites on the Internet, to transmit and receive graphics (e.g., maps), and to execute streaming audio and/or video applications. Such wireless devices may operate on a cellular network, on a wireless local area network (“WLAN”), or on both of these types of networks.

In addition, consumer products such as wireless devices, cellular telephones, handheld devices, and automobiles often incorporate global positioning system (“GPS”) and triangulation techniques based on network information and other information that enable a user to determine exactly where she or he is at any time, or more specifically, where a given location-aware and network-enabled device or object is located at a given time. Furthermore, many of these products have Internet access via a variety of wireless technologies.

However, applications running on current wireless devices have yet to take full advantage of available positioning technology.

A need therefore exists for an improved method and system for providing permissions-based locating services and location-based advertising for wireless and other devices. Accordingly, a solution that addresses, at least in part, the above and other shortcomings is desired.

### SUMMARY OF THE INVENTION

According to one aspect of the invention, there is provided a method in a server coupled to a device through a network for delivering message content to the device, the method comprising: maintaining at the server a message content store, the message content store including message content sorted by geographic position, class, and subclass; receiving at the server from the device a request message for message content, the request message including a geographic position of the device, an extent of a geographic region surrounding the geographic position of the device, a class, and a subclass; determining at the server the message content using the geographic position, the extent, the class, and the subclass; and, sending a response message including the message content from the server to the device, wherein the message content is displayed on a display screen of the device.

In accordance with further aspects of the present invention there is provided an apparatus such as a data processing system and a wireless device, a method for adapting these, as well as articles of manufacture such as a computer readable medium or product having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a data processing system in accordance with an embodiment of the invention;

FIG. 2 is a block diagram illustrating a wireless communications system in accordance with an embodiment of the invention;

FIG. 3 is a block diagram illustrating a wireless communications system having multiple client types in accordance with an embodiment of the invention;

FIG. 4 is a block diagram illustrating a proximity-based feed system in accordance with an embodiment of the invention;

FIG. 5 is a block diagram illustrating a transportation information system in accordance with an embodiment of the invention; and,

FIG. 6 is a flow chart illustrating operations of modules within a data processing system coupled to a device through a network for delivering message content to the device, in accordance with an embodiment of the invention.

It will be noted that throughout the appended drawings, like features are identified by like reference numerals.

### DETAILED DESCRIPTION OF THE PREFERRED EMBODIMENTS

In the following description, details are set forth to provide an understanding of the invention. In some instances, certain software, circuits, structures and methods have not been described or shown in detail in order not to obscure the invention. The term “data processing system” is used herein to refer to a machine for processing data, including the computer systems, wireless devices, and network arrangements described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention. The present invention may also be implemented in hardware or in a combination of hardware and software.

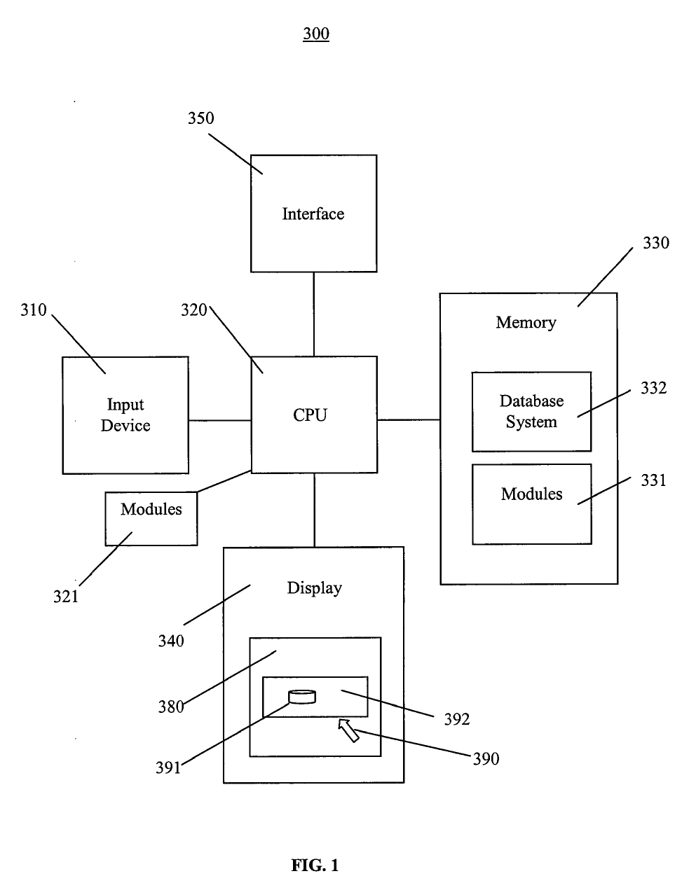

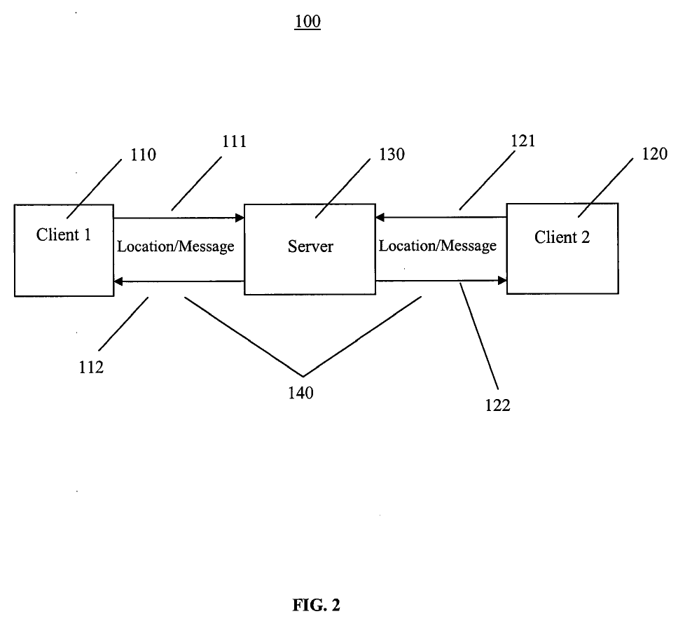

FIG. 1 is a block diagram illustrating a data processing system 300 in accordance with an embodiment of the invention. The data processing system 300 is suitable for generating, displaying, and adjusting presentations in conjunction with a graphical user interface (“GUI”), as described below. The data processing system 300 may be a client and/or server in a client/server system. For example, the data processing system 300 may be a server system or a personal computer (“PC”) system. The data processing system 300 may also be a wireless device or other mobile, portable, or handheld device. The data processing system 300 includes an input device 310, a central processing unit (“CPU”) 320, memory 330, a display 340, and an interface device 350. The input device 310 may include a keyboard, a mouse, a trackball, a touch sensitive surface or screen, a position tracking device, an eye tracking device, or a similar device. The display 340 may include a computer screen, television screen, display screen, terminal device, a touch sensitive display surface or screen, or a hardcopy producing output device such as a printer or plotter. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may include one or more network connections. The data processing system 300 may be adapted for communicating with other data processing systems (e.g., 110, 120, 130 in FIG. 2) over a network (e.g., 140 in FIG. 2) via the interface device 350. For example, the interface device 350 may include an interface to a network such as the Internet and/or another wired or wireless network (e.g., a WLAN, a cellular telephone network, etc.). As such, the interface 350 may include suitable transmitters, receivers, antennae, etc. In addition, the data processing system 300 may include a Global Positioning System (“GPS”) receiver. Thus, the data processing system 300 may be linked to other data processing systems by the network. The CPU 320 may include or be operatively coupled to dedicated coprocessors, memory devices, or other hardware modules 321. The CPU 320 is operatively coupled to the memory 330 which stores an operating system (not shown) for general management of the system 300. The CPU 320 is operatively coupled to the input device 310 for receiving user commands or queries and for displaying the results of these commands or queries to the user on the display 340. Commands and queries may also be received via the interface device 350 and results may be transmitted via the interface device 350. The data processing system 300 may include a database system 332 (or store) for storing data and programming information. The database system 332 may include a database management system and a database and may be stored in the memory 330 of the data processing system 300. In general, the data processing system 300 has stored therein data representing sequences of instructions which when executed cause the method described herein to be performed. Of course, the data processing system 300 may contain additional software and hardware a description of which is not necessary for understanding the invention.

Thus, the data processing system 300 includes computer executable programmed instructions for directing the system 300 to implement the embodiments of the present invention. The programmed instructions may be embodied in one or more hardware modules 321 and/or software modules 331 resident in the memory 330 of the data processing system 300 or elsewhere (e.g., 320). Alternatively, the programmed instructions may be embodied on a computer readable medium or product (e.g., a compact disk (“CD”), a floppy disk, etc.) which may be used for transporting the programmed instructions to the memory 330 of the data processing system 300. Alternatively, the programmed instructions may be embedded in a computer-readable signal or signal-bearing medium (or product) that is uploaded to a network by a vendor or supplier of the programmed instructions, and this signal or signal-bearing medium (or product) may be downloaded through an interface (e.g., 350) to the data processing system 300 from the network by end users or potential buyers.

A user may interact with the data processing system 300 and its hardware and software modules 321, 331 using a graphical user interface (“GUI”) 380. The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input device 310 such as a mouse. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input device (e.g., a mouse) 310 to position a pointer or cursor 390 over an object (e.g., an icon) 391 and by “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

FIG. 2 is a block diagram illustrating a wireless communications system 100 in accordance with an embodiment of the invention. The wireless communication system 100 includes two client systems (e.g., wireless devices) 110, 120 coupled to a server system 130 over a wireless network 140. Each of the client systems and the server system may be a data processing system 300 or include features of the data processing system 300 shown in FIG. 1. According to the present invention, each wireless device 110, 120 calculates or otherwise determines its position 432 from available locating services such as the Global Positioning System (“GPS”), and sends it (along with a message or other content, if desired) 111, 121 to a central holding point such as the server 130 over the network 140. As such, according to one embodiment, each wireless device 110,120 may include a GPS receiver module 321. Each wireless device 110, 120 may also connect to the server 130 to pick up or receive a message 112,122 providing the location of one or more other devices 120,110. FIG. 2 thus illustrates how one device 110 can “see” the location of another device 120 via the server 130. According to one embodiment, a client application on one device (e.g., 110) may display an interactive map (e.g., 470, 570) with an icon 391 over the current location of a person or object (e.g., 120) of interest on the display screen 340 of the device 110.

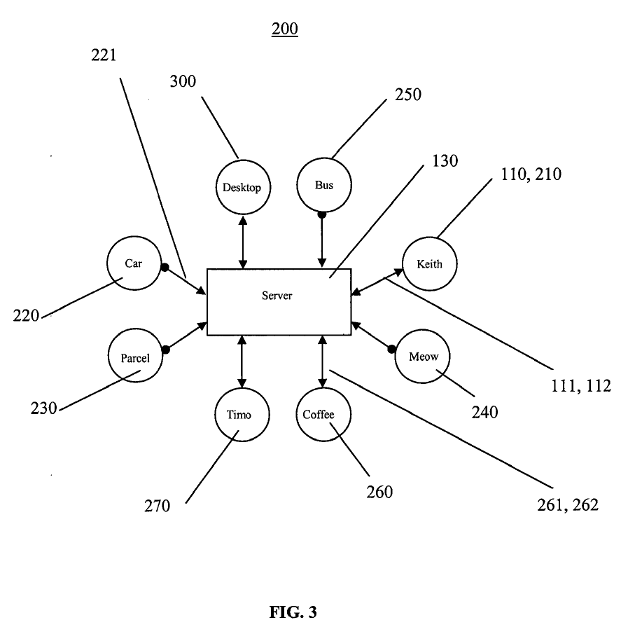

FIG. 3 is a block diagram illustrating a wireless communications system 200 having multiple client types in accordance with an embodiment of the invention. According to one embodiment, the concept of “client” is extended to include not only a wireless device 110, 120 held by a person 210 but also to include objects and other mobile entities such as cars 220, parcels 230, pets 240, keys, buses 250, etc., that may be equipped with a wireless device (e.g., 110, 120, 300) such that the locations of these “location-aware” and networked entities, which are important to one or more users (e.g., 210), are known (i.e., by sending a message 221 to the server 130 which then sends a message 112 to the device 110). In this way, a user 210 may know, for example, if he should run to catch the next bus 250, he may know where his pet 240 is if it has gone missing, know what street 460 to look on for his car 220, catch up with a friend 270 if the friend is nearby, and observe his parcel 230 in transit as it moves towards his mailbox.

According to another embodiment, the concept of “client” is extended to include static or stationary objects that may be beneficially made aware of other objects such as moving objects (instead of moving objects being interested in other moving objects). For example, a business such as a coffee shop 260 may “see” potential customers (e.g., 110, 210) walking past its premises (i.e., by receiving a message 111, 262 from the server 130) and send an advertisement (“ad”) message 261, 112 (i.e., via the server 130) describing a new flavoured drink, or a theatre may send an event message about the current production on stage. As such, each static or stationary object may be equipped with a wireless device (e.g., 110, 120) or data processing system 300. According to one embodiment, the content 481 of the message 420 may be presented on the display screen 340 of the device 110. According to one embodiment, the content 481 of the message 112 maybe presented in a message content presentation 480 on the display screen 340 of the device 110. According to one embodiment, the content 481 of the message 112 may be presented in a message content presentation 480 within an interactive map presentation 470 on the display screen 340 of the device 110.

There are a number of features that applications running on the client 110, 120 and server 130 may support for the benefit of stakeholders such as the device 110 owner 210 and various businesses and services (e.g., 250, 260). Some of these include a history of messages associated with locations, a history of locations, paths connecting locations over time, bookmarked locations, and security in order to provide a means to selectively allow and disallow others information pertaining to location. In addition, a client application may also extend the already existing list of names and addresses on the client device into a visual interactive map format or presentation 470, 570.

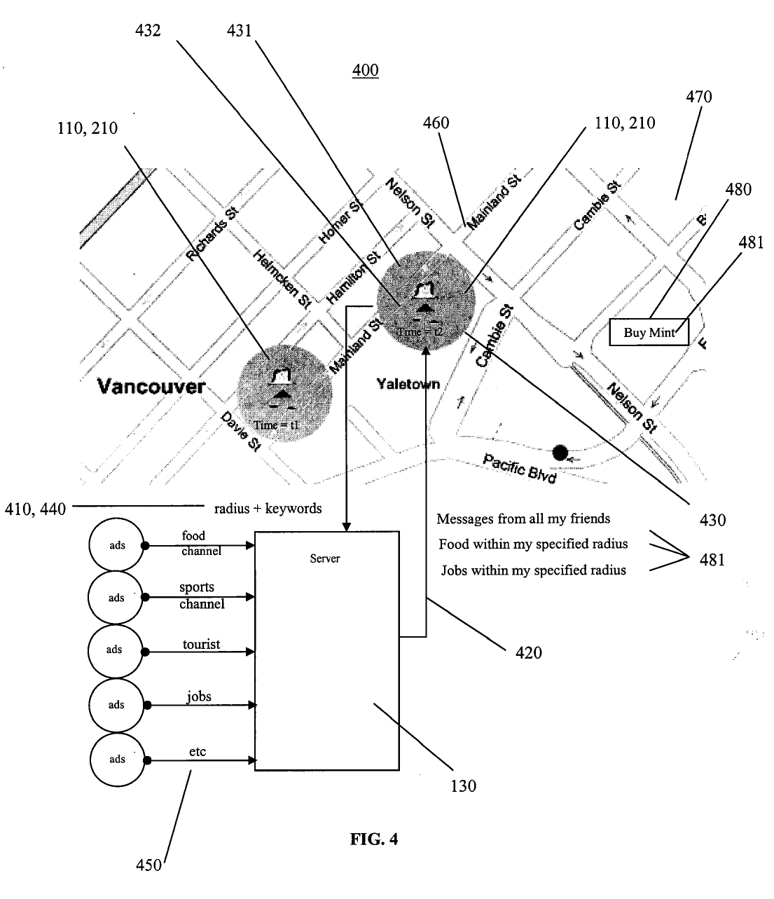

FIG. 4 is a block diagram illustrating a proximity-based feed system 400 in accordance with an embodiment of the invention. The proximity-based feed system 400 provides an environment in which a user 210 (i.e., via device 110) may specify (i.e., via message 410 or 111) a radius 430 (i.e., defining an extent of a geographic region 431 surrounding the geographic position 432 of the user 110, 210) to the right-here-right-now server 130 of allowable incoming messages 420 or 112 (i.e., from the server 130). This environment maybe particularly useful for advertisers who want to attract the attentions of users 210 walking past their shop (e.g., 260) or event venue. The proximity-based feed message 420 may be further differentiated with one or more keywords 440 (or message content subclasses) and channels (e.g., coffee, hiring, chocolate, sports, transportation, buses, subways, etc.) 450 (or message content classes) specified (i.e., via message 410) by the user 210 via her wireless device 110 such that only those messages 420 that meet these settings are directed to the user 210 (all others being filtered out). According to one embodiment, the content 481 of the message 420 may be presented on the display screen 340 of the device 110. According to one embodiment, the content 481 of the message 420 may be presented in a message content presentation 480 on the display screen 340 of the device 110. According to one embodiment, the content 481 of the message 420 may be presented in a message content presentation 480 within an interactive map presentation 470 on the display screen 340 of the device 110.

In FIG. 4, the user 210 (with her wireless device 110) has set the content 481 of the proximity-based feed 420 for messages from her friends 450 to infinity 430, and for advertisers to five meters 430 with further differentiation provided by the keywords “chocolate” 440 (i.e., for “food” channel 450) and “hiring” 440 (i.e., for “jobs” channel 450). As the user 210 moves up the street 460, advertiser “Blends” informs her (at time t1) that they have a mint “chocolate” drink special, $1.99, for St. Patrick's Day. As she moves further along (at time t2), she discovers that Idelix Software Inc. is “hiring” (e.g., software developers and a product manager).

This embodiment makes it possible for advertisers to link in when users 110, 210 have opened their channels 450 to educational and tourist content 481. For example, as a Vancouver tourist 110, 210 walks past the “Roundhouse” site, they may receive a message (i.e., a feed) 420 explaining that the Roundhouse was one of Vancouver's first train stations. The message 420 may indicate that the Roundhouse was built in 1920 and that there are pictures of old Vancouver (for viewing free of charge) located inside along with a coffee shop. Similarly, the tourist 210 may be provided with a message 420 explaining that nearby “Shangri-La” site is the tallest and newest building in Vancouver and has 140 residential units and 3 cinemas which are now playing “Harry Potter”, “Sweeny Ted”, and “Atonements”. According to one embodiment, the message 420 or 112 may include one or more of text, graphics, audio, and video.

Advantageously, the proximity-based feed system 400 gives control over received messages 420 to the user 110, 210. The user 110, 210 may choose to opt in or out from receiving messages 420. Moreover, the user 210 may define via her wireless device 110 (or otherwise) which channels 450 she wants to listen to or receive messages 420 from.

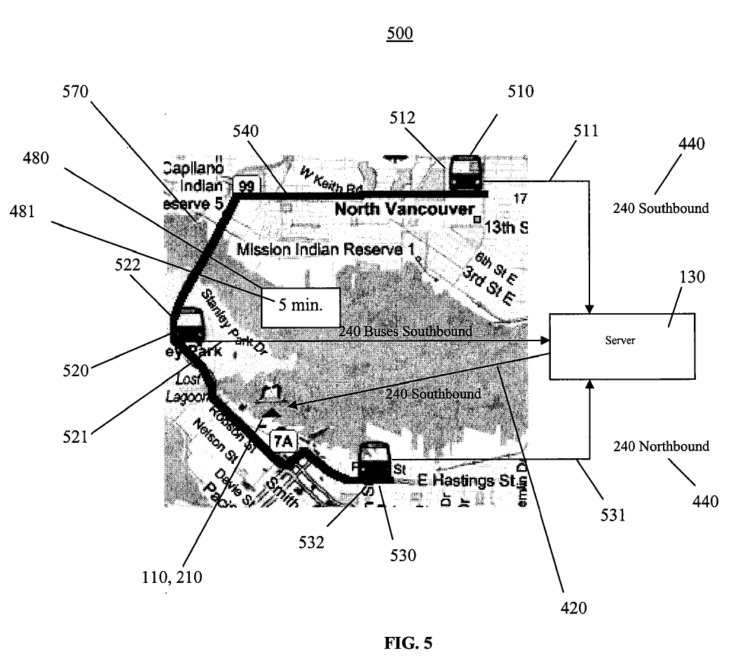

FIG. 5 is a block diagram illustrating a transportation information system 500 in accordance with an embodiment of the invention. The real-time features of the proximity-based feed system 400 described above may be applied to obtain up-to-the-minute data on arrival/departure times of airplanes, trains, subways, and buses, for example. The moving transportation vehicles (e.g., buses) 510, 520, 530 transmit 511, 521, 531 their locations to the server 130. A user 110, 210 who is interested in bus schedules makes them a “friend” (e.g., an instant messaging friend, an email friend, opens bus channel 450, etc.) and receives 420 the buses' latest positions 512, 522, 532 and expected arrival/departure times (e.g., at/from these positions 512, 522, 532, bus stops nearby, etc.). In FIG. 5, current bus locations 512, 522, 532 are continuously transmitted 511, 521, 531 to the server 130 and from there can be picked up by the user 210 (via the user's wireless device 110). This transportation information system 500 may be used in conjunction with or be implemented using the proximity-based feed system 400. According to one embodiment, the user 110, 210 may open a bus information channel 450 and use a keyword 440 (e.g., “240 Southbound”, “240 Northbound”, etc.) to specify 410 a bus route 540 that the user wants to receive bus movement information messages 420 and content 481 for. According to one embodiment, the content 481 of the message 420 may be presented on the display screen 340 of the device 110. According to one embodiment, the content 481 of the message 420 may be presented in a message content presentation 480 on the display screen 340 of the device 110. According to one embodiment, the content 481 of the message 420 may be presented in a message content presentation 480 within an interactive map presentation 570 on the display screen 340 of the device 110.

Aspects of the above described method may be summarized with the aid of a flowchart.

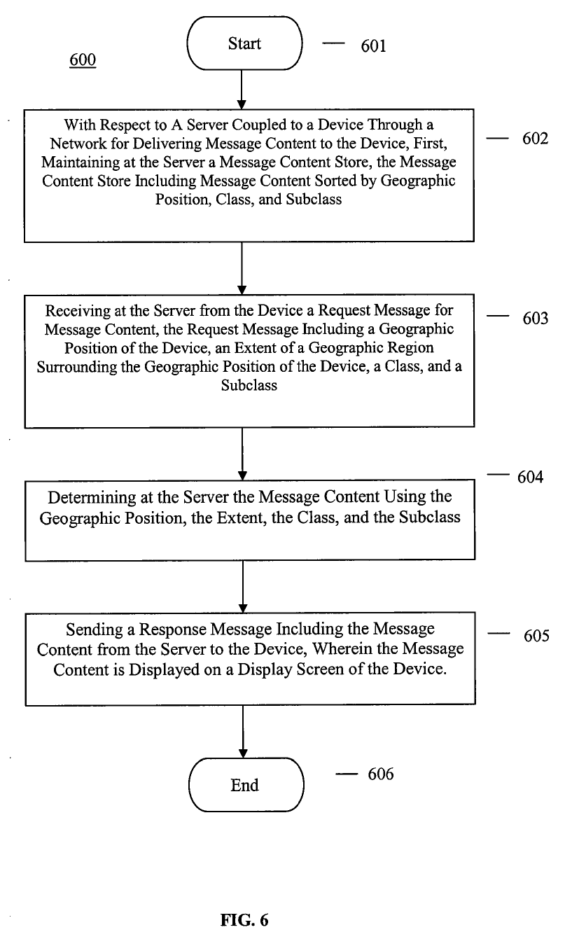

FIG. 6 is a flow chart illustrating operations 600 of modules 321, 331 within a data processing system (e.g., 130, 300) coupled to a device (e.g., 110) through a network (e.g., 140) for delivering message content 481 to the device 110, in accordance with an embodiment of the invention.

At step 601, the operations 600 start.

At step 602, a message content store 330 is maintained at the server 130, the message content store 330 including message content 481 sorted by geographic position, class, and subclass.

At step 603, a request message (e.g., 111, 410) for message content 481 is received at the server 130 from the device 110, the request message 111 including a geographic position 432 of the device 110, an extent of a geographic region 431 surrounding the geographic position 432 of the device 110, a class 450, and a subclass 440.

At step 604, the message content 481 is determined at the server 130 using the geographic position 432, the extent 431, the class 450, and the subclass 440.

At step 605, a response message (e.g., 112, 420) including the message content 481 is sent from the server 130 to the device 110, wherein the message content 481 is displayed on a display screen 340 of the device 110.

At step 606, the operations 600 end.

In the above method, the device 110 may be a wireless device and the network may be a wireless network. The wireless device 110 maybe a mobile wireless device. The message content store 330 may be populated with message content 481 received from a plurality of devices 110, 120 coupled to the server 130 through the network 140 or otherwise. The devices 110, 120 may include mobile wireless devices, stationary wireless devices, and stationary wired devices. The mobile wireless devices may be located in vehicles (e.g., 510, 520, 530) or may be handheld and the stationary wireless devices and stationary wired devices may be located in homes or businesses. The vehicles may include buses, subways, streetcars, trains, airplanes, and ships. The class 450 maybe a vehicle type (e.g., a bus), the subclass 440 may be a route identifier (e.g., “240 Southbound”) for the vehicle type, and the message content 481 may be an arrival time (e.g., “5 min.”) of a vehicle of the vehicle type travelling on a route 540 identified by the route identifier within the extent 431. The arrival time 481 may be displayed with or within 480 a map presentation 570 on the display screen 340 of the device 110. The device 110 maybe a mobile wireless device and the network 140 maybe wireless network. The class 450 may be a business type (e.g., “food”), the subclass 440 may be a product or service type (e.g., “chocolate”), and the message content 481 may be an advertisement (e.g., “Buy Mint”) for a product or service (e.g., “mint chocolate drink”) of the product or service type available from a business (e.g., “Blends”) of the business type located within the extent 431. The advertisement 481 may be displayed with or within 480 a map presentation 470 on the display screen 340 of the device 110. Again, the device 110 may be a mobile wireless device and the network 140 may be a wireless network. The class 450 may be an information source (e.g., tourism office), the subclass 440 may be an information type (e.g., history), and the message content 481 may be information (e.g., “Built in 1920”) of the information type available from the information source and relating to a location (e.g., “Roundhouse”) within the extent 431. The information 481 may be displayed with or within 480 a map presentation 470, 570 on the display screen 340 of the device 110. Again, the device 110 may be a mobile wireless device and the network 140 may be a wireless network. The class 450 may be a device type, the subclass 440 may be a device identifier, and the message content 481 may be a geographic position of a device (e.g., 120) of the device type having the device identifier within the extent 432. The geographic position 481 may be displayed with or within 480 a map presentation 470, 570 on the display screen 340 of the device 110. Again, the device 110 maybe a mobile wireless device and the network 140 maybe a wireless network. The device type 450 may be a client type and the device identifier 440 may be an address. The device type 450 may be mobile wireless devices, the device 120 of the device type may be a mobile wireless device, and the device identifier 440 may be a telephone number. The class 450 may be a device type, the subclass 440 may be a device identifier, and the message content 481 may be a communication from a device 120 of the device type having the device identifier within the extent 431. The communication 481 may be displayed with or within 480 a map presentation 470, 570 on the display screen 340 of the device 110. Again, the device 110 may be a mobile wireless device and the network 140 may be a wireless network. The device type 450 maybe a client type and the device identifier 440 may be an address. The device type 450 may be a mobile wireless devices, the device 120 of the device type may be mobile wireless device, and the device identifier 440 may be a telephone number. The communication 481 may include one or more of a voice communication, an electronic mail communication, an instant messaging communication, and a data communication. The geographic position 432 of the device 110 may be determined from a Global Positioning System (“GPS”) receiver included in the device 110. The extent 431 may be defined by a radius 430 extending from the device 110. The radius 430 may be infinite. At least one of the class 450 and the subclass 440 maybe a wildcard (e.g., all classes, all subclasses, etc.). The message content 481 may include one or more of text, graphics, audio, and video. The class 450 and subclass 440 may be keywords and the message content store 330 may be a database 332. The determining may include searching the message content store 330 using the geographic position 432, the extent 431, the class 450, and the subclass 440 as search parameters. And, the determining may include filtering the message content store 330 using the geographic position 432, the extent 431, the class 450, and the subclass 440 as filter parameters.

According to one embodiment, each of the above steps 601-606 may be implemented by a respective software module 331. According to another embodiment, each of the above steps 601-606 may be implemented by a respective hardware module 321. According to another embodiment, each of the above steps 601-606 may be implemented by a combination of software 331 and hardware modules 321.

While this invention is primarily discussed as a method, a person of ordinary skill in the art will understand that the apparatus discussed above with reference to a data processing system 300 (or 110, 120, 130), may be programmed or configures to enable the practice of the method of the invention. Moreover, an article of manufacture for use with a data processing system 300, such as a pre-recorded storage device or other similar computer readable medium or product including program instructions recorded thereon, may direct the data processing system 300 to facilitate the practice of the method of the invention. It is understood that such apparatus and articles of manufacture also come within the scope of the invention.

In particular, the sequences of instructions which when executed cause the method described herein to be performed by the data processing system 300 can be contained in a data carrier product according to one embodiment of the invention. This data carrier product can be loaded into and run by the data processing system 300. In addition, the sequences of instructions which when executed cause the method described herein to be performed by the data processing system 300 can be contained in a computer software product according to one embodiment of the invention. This computer software product can be loaded into and run by the data processing system 300. Moreover, the sequences of instructions which when executed cause the method described herein to be performed by the data processing system 300 can be contained in an integrated circuit product (e.g., a hardware module or modules 321) which may include a coprocessor or memory according to one embodiment of the invention. This integrated circuit product can be installed in the data processing system 300.

The embodiments of the invention described above are intended to be exemplary only. Those skilled in the art will understand that various modifications of detail may be made to these embodiments, all of which come within the scope of the invention.

What is claimed is:

1. A method in a server coupled to a device through a network for delivering message content to the device, the method comprising:
maintaining at the server a message content store, the message content store including message content sorted by geographic position, class, and subclass;
receiving at the server from the device a request message for message content, the request message including a geographic position of the device, an extent of a geographic region surrounding the geographic position of the device, a class, and a subclass;
determining at the server the message content using the geographic position, the extent, the class, and the subclass; and,
sending a response message including the message content from the server to the device, wherein the message content is displayed on a display screen of the device.

2. The method of claim 1 wherein the device is a wireless device and the network is a wireless network.

3. The method of claim 2 wherein the wireless device is a mobile wireless device.

4. The method of claim 1 wherein the message content store is populated with message content received from a plurality of devices coupled to the server through the network or otherwise.

5. The method of claim 4 wherein the devices include mobile wireless devices, stationary wireless devices, and stationary wired devices.

6. The method of claim 5 wherein the mobile wireless devices are located in vehicles or are handheld and wherein the stationary wireless devices and stationary wired devices are located in homes or businesses.

7. The method of claim 6 wherein the vehicles include buses, subways, streetcars, trains, airplanes, and ships.

8. The method of claim 1 wherein the class is a vehicle type, wherein the subclass is a route identifier for the vehicle type, and wherein the message content is an arrival time of a vehicle of the vehicle type travelling on a route identified by the route identifier within the extent.

9. The method of claim 8 wherein the arrival time is displayed with or within a map presentation on the display screen of the device.

10. The method of claim 8 wherein the device is a mobile wireless device and the network is a wireless network.

11 The method of claim 1 wherein the class is a business type, wherein the subclass is a product or service type, and wherein the message content is an advertisement for a product or service of the product or service type available from a business of the business type located within the extent.

12. The method of claim 11 wherein the advertisement is displayed with or within a map presentation on the display screen of the device.

13. The method of claim 11 wherein the device is a mobile wireless device and the network is a wireless network.

14. The method of claim 1 wherein the class is an information source, wherein the subclass is an information type, and wherein the message content is information of the information type available from the information source and relating to a location within the extent.

15. The method of claim 14 wherein the information is displayed with or within a map presentation on the display screen of the device.

16. The method of claim 14 wherein the device is a mobile wireless device and the network is a wireless network.

17. The method of claim 1 wherein the class is a device type, wherein the subclass is a device identifier, and wherein the message content is a geographic position of a device of the device type having the device identifier within the extent.

18. The method of claim 17 wherein the information is displayed with or within a map presentation on the display screen of the device.

19. The method of claim 17 wherein the device is a mobile wireless device and the network is a wireless network.

20. The method of claim 17 wherein the device type is a client type and the device identifier is an address.

21. The method of claim 17 wherein the device type is mobile wireless devices, the device of the device type is a mobile wireless device, and the device identifier is a telephone number.

22. The method of claim 1 wherein the class is a device type, wherein the subclass is a device identifier, and wherein the message content is a communication from a device of the device type having the device identifier within the extent.

23. The method of claim 22 wherein the communication is displayed with or within a map presentation on the display screen of the device.

24. The method of claim 22 wherein the device is a mobile wireless device and the network is a wireless network.

25. The method of claim 22 wherein the device type is a client type and the device identifier is an address.

26. The method of claim 22 wherein the device type is mobile wireless devices, the device of the device type is a mobile wireless device, and the device identifier is a telephone number.

27. The method of claim 22 wherein the communication includes one or more of a voice communication, an electronic mail communication, an instant messaging communication, and a data communication.

28. The method of claim 1 wherein the geographic position of the device is determined from a Global Positioning System (“GPS”) receiver included in the device.

29. The method of claim 1 wherein the extent is defined by a radius extending from the device.

30. The method of claim 29 wherein the radius is infinite.

31. The method of claim 1 wherein at least one of the class and the subclass is a wildcard.

32. The method of claim 1 wherein the message content includes one or more of text, graphics, audio, and video.

33. The method of claim 1 wherein the class and subclass are keywords and the message content store is a database.

34. The method of claim 1 wherein the determining includes searching the message content store using the geographic position, the extent, the class, and the subclass as search parameters.

35. The method of claim 1 wherein the determining includes filtering the message content store using the geographic position, the extent, the class, and the subclass as filter parameters.

36. A server system coupled to a device through a network for delivering message content to the device, the server system comprising:
a processor coupled to memory and an interface to the network;
a database within the memory for maintaining a message content store, the message content store including message content sorted by geographic position, class, and subclass; and,
modules within the memory or server system and executed or controlled by the processor, the modules including:
a module for receiving at the server system from the device a request message for message content, the request message including a geographic position of the device, an extent of a geographic region surrounding the geographic position of the device, a class, and a subclass;
a module for determining at the server system the message content using the geographic position, the extent, the class, and the subclass; and,
a module for sending a response message including the message content from the server system to the device, wherein the message content is displayed on a display screen of the device.

37. The server system of claim 36 wherein the device is a mobile wireless device and the network is a wireless network.

38. The server system of claim 36 wherein the modules are one or more of hardware modules and software modules.
